(19) United States
(12) Patent Application Publication
(10) Pub. No.: US 2024/0195755 A1
(43) Pub. Date: Jun. 13, 2024

(54) Network Tapped Data Diode

(71) Applicant: Fend Incorporated, Arlington, VA (US)

(72) Inventors: Sang Cheon Lee, Oakton, VA (US); Colin Patrick Dunn, Falls Church, VA (US); Philip Quebe, Middlebrook, VA (US); Nicholas Norwood, Hiram, GA (US)

(73) Assignee: Fend Incorporated, Arlington, VA (US)

(21) Appl. No.: 18/533,737

(22) Filed: Dec. 8, 2023

Related U.S. Application Data
(60) Provisional application No. 63/386,817, filed on Dec. 9, 2022.

(51) Int. Cl. H04L 49/20; H04L 43/062; H04L 49/253

(52) U.S. Cl. CPC H04L 49/208; H04L 43/062; H04L 49/254

(57) ABSTRACT

A data diode provides a flexible device for collecting data from a data source and transmitting the data to a data destination using one-way data transmission. On-board processing elements allow the data diode to identify automatically the type of connectivity provided to the data diode and configure the data diode to handle the identified type of connectivity. A network tap allows monitoring network traffic on the source side of the data diode.

### CROSS-REFERENCE TO RELATED APPLICATIONS

This application claims the benefit of U.S. Prov. Pat. App. No. 63/386,817, filed Dec. 9, 2022, and entitled “Ethernet network tapped data diode,” the contents of which are incorporated by reference in their entirety for all purposes.

### TECHNICAL FIELD

The present invention relates to the field of security, and in particular to a compact network device that provides hardware-enforced one-way data transfer from a protected data source with a network tap.

### SUMMARY

In a first aspect, a data diode comprises a first network interface circuitry, comprising: a first processing element; a first network connector, coupled to the first processing element; and a second network interface circuitry, comprising: a second processing element; and a second network connector, coupled to the second processing element; a one-way data bridge coupled between the first processing element and the second processing element that allows data flow from the first processing element to the second processing element and physically prohibits data flow from the second processing element to the first processing element; and a network tap, comprising: a first network port; a second network port; and a network switch, configured to mirror network traffic received from the first network port to both the first processing element and the second network port.

In a second aspect, a network tap comprises a one-way data bridge having a first end and a second end that allows data flow from the first end to the second end and physically prohibits data flow from the second end to the first end; a first network port; a second network port; and a network switch, configured to mirror network traffic received from the first network port to both the second network port and the first end of the one-way data bridge.

In a third aspect, a method of tapping a network, comprises receiving network traffic by a first network port; sending the network traffic from the first network port to a network switch; mirroring the network traffic by the network switch to both a first processing element of a data diode and a second network port; and sending the network traffic or information about the network traffic from the first processing element of the data diode to a second processing element of the data diode via a one-way data bridge that physically prohibits data flow from the second processing element to the first processing element.

### BACKGROUND ART

Computer and network security is an area of considerable concern. While there is great interest in being able to remotely monitor resources such as industrial facilities across computer networks, lack of security of those monitored resources has required the development of specialized devices that provide defenses against security threats to computers, networks, and other devices in the monitored resources that go beyond the protection of firewalls and other traditional Internet security software and hardware systems. For high-security resources, such as those used by government agencies and some commercial facilities, such as computer-controlled industrial facilities, energy, or water utilities, conventional firewall and other security systems may not provide reliable enough protection from undesired intrusions.

Today, we consider one single, high-value asset to be critical because to lose it would cause widespread disruption (for example, a power plant), but in aggregate, thousands of pieces of commercial equipment represent a similar threat and the number of attack vectors is exponentially higher. Widespread cyberattacks on commercial or “subcritical” equipment, from building chillers to sewage pumps, would cause economic disruption and compromise public safety. For example, attacks on the air handlers in a region's hospital network, the refrigeration equipment at pharmacies and grocery stores, or the chilled water pumps serving Virginia's data centers could have a severe impact.

For these types of resources, one-way data transfer may be a critical requirement to isolate the protected network from intrusion by malware or other malicious actors outside the protected network. While conventional Internet firewalls and software systems such as specially configured operating systems may be designed to restrict data transfer to unidirectional data flow, software-based one-way data transfer systems are difficult to validate and verify, and may be subject to intentional or inadvertent misconfiguration that may allow data leakage or intrusions in the reverse direction.

Malicious attacks to date have focused largely on data theft or network disruption, but attacks on physical assets are becoming more frequent. Attackers can compromise IoT devices and, for example, (a) Recruit devices into botnets used for distributed denial of service (DDOS) attacks; (b) Open a back door into a corporate network; or (c) Change the operating behavior of the device, leading to device failure or safety concerns.

Data diode devices have been developed to provide hardware-enforced one-way data transfer, using techniques as simple as severing the receive pin in an RS-232 cable to more complex techniques involving the use of optical cables or opto-isolator components that transfer electrical signals between two isolated circuits with light. An opto-isolator (also called an optocoupler) uses an optical emitter such as an LED that generates light responsive to electrical signals, while an optical sensor such as a phototransistor receives the light and converts the light into electrical signals. Because there is electrical isolation between the two sides of the opto-isolator, this physically enforces one-way communication across the opto-isolator.

However, because common Internet protocols depend upon two-way communication, a data diode requires additional components beyond an opto-isolator (or a simple serial cable with the receive line interrupted) to allow effective one-way communication.

Traditional data diodes are used to protect critical infrastructure, such as nuclear reactors or oil refineries by broadcasting equipment status in a one-way manner. These traditional data diodes are expensive and have required customization by skilled implementation teams.

### BRIEF DESCRIPTION OF DRAWINGS

The accompanying drawings, which are incorporated in and constitute a part of this specification, illustrate an implementation of apparatus and methods consistent with the present invention and, together with the detailed description, serve to explain advantages and principles consistent with the invention. In the drawings,

FIG. 1 is a high-level block diagram illustrating a data diode system according to one embodiment.

FIG. 2 is a block diagram illustrating components of a data diode according to one embodiment.

FIG. 3 is a perspective view of a housing for the data diode system according to one embodiment.

### DESCRIPTION OF EMBODIMENTS

In the following description, for purposes of explanation, numerous specific details are set forth in order to provide a thorough understanding of the invention. It will be apparent, however, to one skilled in the art that the invention may be practiced without these specific details. In other instances, structure and devices are shown in block diagram form in order to avoid obscuring the invention. References to numbers without subscripts are understood to reference all instances of subscripts corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment of the invention, and multiple references to “one embodiment” or “an embodiment” should not be understood as necessarily all referring to the same embodiment.

Although some of the following description is written in terms that relate to software or firmware, embodiments can implement the features and functionality described herein in software, firmware, or hardware as desired, including any combination of software, firmware, and hardware. References to daemons, drivers, engines, modules, or routines should not be considered as suggesting a limitation of the embodiment to any type of implementation. The actual specialized control hardware or software code used to implement these systems or methods is not limiting of the implementations. Thus, the operation and behavior of the systems and methods are described herein without reference to specific software code with the understanding that software and hardware can be used to implement the systems and methods based on the description herein

As used herein, satisfying a threshold may, depending on the context, refer to a value being greater than the threshold, greater than or equal to the threshold, less than the threshold, less than or equal to the threshold, equal to the threshold, or the like, depending on the context.

Although particular combinations of features are recited in the claims and disclosed in the specification, these combinations are not intended to limit the disclosure of various implementations. Features may be combined in ways not specifically recited in the claims or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such.

The terms “a,” “an,” and “the” are not intended to refer to a singular entity unless explicitly so defined, but include the general class of which a specific example may be used for illustration. The use of the terms “a” or “an” may therefore mean any number that is at least one, including “one,” “one or more,” “at least one,” and “one or more than one.”

The term “or” means any of the alternatives and any combination of the alternatives, including all of the alternatives, unless the alternatives are explicitly indicated as mutually exclusive.

The phrase “at least one of” when combined with a list of items, means a single item from the list or any combination of items in the list. The phrase does not require all of the listed items unless explicitly so defined.

As used herein, the term “a computer system” can refer to a single computer or a plurality of computers working together to perform the function described as being performed on or by a computer system.

In this description, the term “couple” or “couples” means either an indirect or direct wired or wireless connection. Thus, if a first device couples to a second device, that connection may be through a direct connection or an indirect connection via other devices and connections. The recitation “based on” means “based at least in part on.” Therefore, if X is based on Y, X may be a function of Y and any number of other factors.

As used herein, the term “processing element” can refer to a single hardware processing element or a plurality of hardware processing elements that together may be programmed to perform the indicated actions. The hardware processing elements may be implemented as virtual hardware processing elements of a virtual programmable device hosted on a physical hardware device. Instructions that when executed program the processing element to perform an action may program any or all of the processing elements to perform the indicated action. Where the processing element is one or more multi-core processors, instructions that when executed program the processing element to perform an action may program any or all of the multiple cores to perform the indicated action.

As used herein, the term “malware” can refer to any software used to disrupt the operation of a programmable device, gather sensitive information, or gain access to private systems or networks. Malware includes computer viruses (including worms, Trojan horses, etc.), Bots, ransomware, spyware, adware, scareware, and any other type of malicious program.

As used herein, the term “medium” can refer to a single physical medium or a plurality of media that together store the information described as being stored on the medium.

As used herein, the term “memory” can refer to a single memory device or a plurality of memory devices that together store the information described as being stored on the medium. The memory may be any type of storage device, including random access memory, read-only memory, optical and electromechanical disk drives, etc.

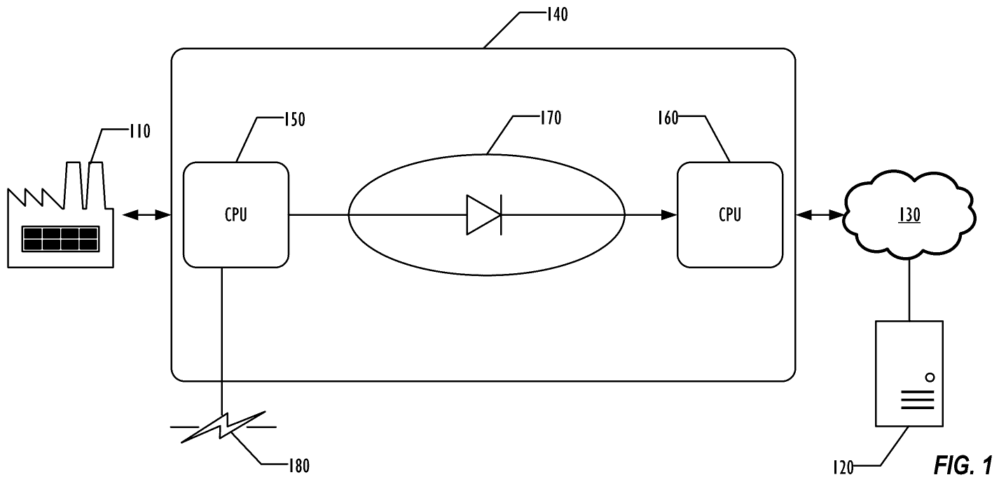

FIG. 1 is a block diagram illustrating the use of a data diode according to one embodiment. In this example, a data source 110, such as a factory or other protected facility, is to provide data to a destination 120, such as a monitoring server. In some implementations, either or both of the source 110 and destination 120 may be directly connected to the data diode 140, or may be connected to the data diode 140 by one or more networks, such as the cloud network 130 illustrated FIG. 1. Although a single source 110 and a single destination 120 are illustrated in FIG. 1 for clarity of the drawing, the data diode 140 may support one-way communications from multiple sources 110 and multiple destinations 120 as desired. In the example illustrated in FIG. 1, the source is directly connected to the data diode 140 and connected to destination 120 that is a server connected via a cloud network 130; however, the data diode 140 may be connected at the source to any type of equipment, directly or indirectly, with or without an intervening network of any type. Similarly, the data diode 140 may be connected at the destination to any type of equipment, directly or indirectly, with or without an intervening network of any type.

Data diode 140 provides assurance that the data provided by source 110 is sent one-way only, physically preventing data from the destination 120 or elsewhere from reaching source 110. Data diode 140 generally comprises an onboard processing element 150 that communicates with source 110, an onboard processing element 160 that communicates with cloud 130, and a one-way coupler 170 that physically ensures that data passes only from processing element 150 to processing element 160, and not from processing element 160 to processing element 150. Processing elements 150 and 160 are programmed to allow the same data diode 140 to work with any of multiple protocols on either the source or destination side of the data diode, allowing a single model of the data diode 140 to be used in various environments without major configuration effort to accommodate various protocols.

In addition to the features described above, the data diode 140 provides a network tap that allows the data diode 140 to intercept or monitor network traffic on a network link such as network link 180 safely, as described in detail below, providing information captured through the secure one-way coupler 170 to the destination 120. This allows monitoring network traffic with an optically isolated device without the need for hardware external to the data diode 140. One of skill in the art will recognize there are other use cases for a data diode that contains a network tap.

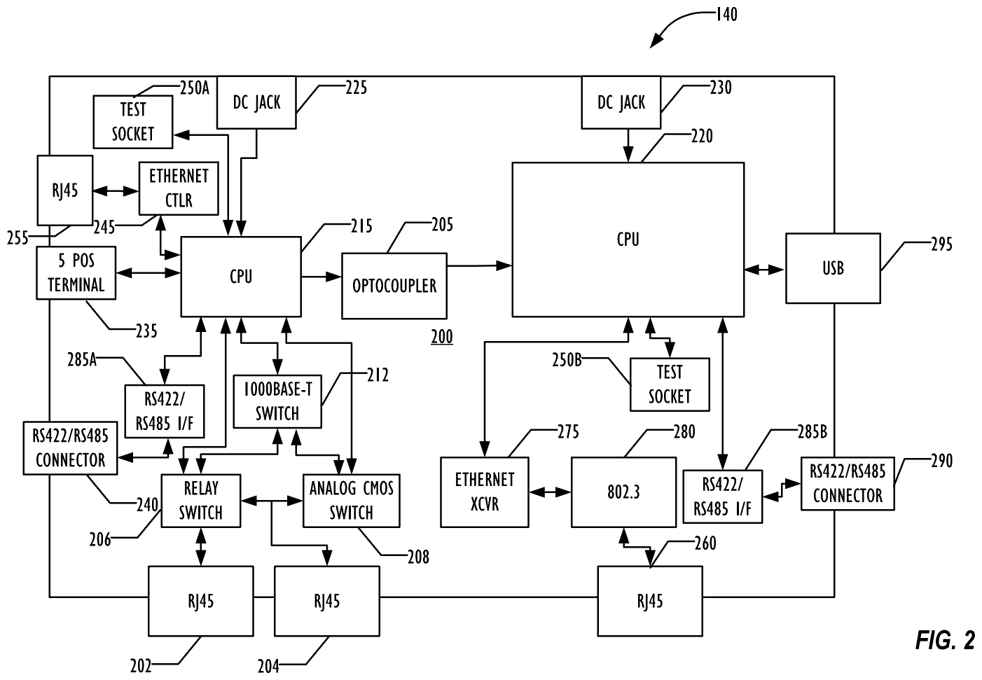

FIG. 2 is a block diagram illustrating an example layout of the components of data diode 140 according to one embodiment. In this figure, certain common elements have been omitted for clarity of the drawing, but one of skill in the art would understand that those elements would be present in an operable embodiment. Connections are illustrated as logical connections between elements, and one of skill in the art would understand that connections between elements in the figure may involve multiple electrical traces instead of the single connector used to illustrate the connections between elements in the figure.

In one embodiment, a circuit board 200 may provide a base for mounting and connecting various components. Although identified as separate components by their function, one of skill in the art would understand that components illustrated as separate components may be combined into integrated components and that components illustrated as a single component may be split into separate components as desired.

The data diode 140 is comprised of two portions that communicate with each other in a one-way manner across one or more one-way data bridges that enforce one-way communication. In some embodiments, photocouplers (also known as optocouplers or optical isolators) may be used for this purpose. In other embodiments, a laser and a photodetector may be used instead of an optocoupler. In other embodiments, an infrared transmitter and receiver may be used. In other embodiments, a non-optical technique may be used, such as an audio speaker and a microphone may be used. In each case, the components provide the ability to enforce one-way communication physically.

As illustrated in FIG. 2, a photocoupler 205 provides one-way data bridges between two processing elements 215, 220, with the photocoupler provided for communication from processing element 215 to processing element 220. Although illustrated as providing one-way communication from processing element 215 to processing element 220, other embodiments may configure the photocoupler 205 for one-way communication from processing element 220 to processing element 215.

No other electrical path connects processing elements 215 and 220. As illustrated in FIG. 2, each “side” of the data diode 140 may have its own power connection through power jacks 225, 230, typically DC power jacks. Although not shown in FIG. 2, in some embodiments each portion of the data diode 140 is implemented with separate grounding, further ensuring there is no path for data to traverse the data diode 140 in the reverse direction from the intended direction.

Processing elements 215, 220 may be any desired type of processing elements, including processors and microcontrollers. An example processing element may be an ARM® Cortex® processor from ARM Limited. (ARM and CORTEX are registered trademarks of ARM Limited.) Each of the processing elements 215, 220 must be powerful enough to perform protocol detection and conversion for a plurality of protocols. Each of processing elements 215 may be programmed with firmware code to perform protocol manipulation to allow the processing element 215, 220 to recognize a communication protocol used by the source 110 and destination 120, and process the communication in a way that successfully allows the one-way communication, even if either or both of the communication protocols used by the source 110 or destination 120 require two-way communication. In such a scenario, one or both of processing elements 215, 220 may communicate in a two-way communication with the source 110 or destination 120 to which the processing element 215, 220 is connected, acting as proxy while performing one-way communication across the optocoupler 205 between processing elements 215 and 220. In some embodiments, the communication protocol used to communicate between processing elements 215 and 220 may differ from either or both of the communication protocols used by source 110 and destination 120. Preferably, the processing elements 215, 220 are programmed to recognize the communication protocols used by source 110 and destination 120 automatically, allowing the data diode 140 to be coupled between source 110 and destination 120 without manual configuration by the user or with minimal configuration as desired. Processing elements 215, 220 may contain onboard memory for storing the firmware used for operating the processing elements 215, 220 in some embodiments. In other embodiments, off-chip memory components (not illustrated in FIG. 2) may be provided and coupled to the processing elements 215, 220.

As illustrated in FIG. 2, the data diode 140 provides a plurality of different type connectors, allowing the data diode 140 to be used in different types of connectivity environments without requiring different models of the data diode 140 that depend upon the desired type of connectivity. As illustrated in FIG. 2, the left side of the figure is configured as the source side for data transport and provides an RS422/RS485 connector 240, a 5-pin connector 235, and an RJ45 connector 255 for Ethernet connection between the processing element 215 and the source 110. Similarly, the right side of the figure is configured as the destination side for data transport and provides a USB connector 295, an RS422/485 connector 290, and an Rj45 connector for Ethernet connections between the processing element 215 and the source 110. In some scenarios, more than one of the connectors on either or both the source or destination portion of the data diode 140 may be operable at the same time. These connector types are illustrative and by way of example only, and other types of connectors may be used on either side of the data diode 140 in addition to or instead of the connectors illustrated in FIG. 2. In other embodiments, a single connector of any desired type may be provided on either side of the data diode 140, and different numbers and types of connectors may be provided on either side of the data diode 140 as desired. Although only a single connector of each type is illustrated in FIG. 2, one of skill in the art will recognize that the data diode 140 is not limited to only a single connector of each type, and multiple connectors of one or more types may be included.

Generally, there is two-way communication between any or all of the connectors 235, 240, and 255 and processing element 215, and between any or all of the connectors 295, 290, and 260 and processing element 220. As illustrated in FIG. 2, RS422/485 connector 240 is coupled to processing element 215 with RS422/RS485 interface 285A, while RS422/RS485 connector 290 is coupled to processing element 220 with RS422/RS485 interface 285B. In other embodiments, the processing elements 215, 220 may be capable of interfacing directly with RS422/RS485 connectors 240, 290 without an intermediary interface. As illustrated in FIG. 2, RJ45 connector 255 communicates with processing element 215 via Ethernet controller 245, while RJ45 connector 260 communicates with processing element 220 via IEEE 802.3 interface 80 and Ethernet transceiver 275. but other types of Ethernet coupling of the RJ45 connectors 255, 260 may be used.

In one embodiment, different components may be used for each “side” of the data diode 140. For example, RJ 45 connector 255 may be implemented in one embodiment with an RB1-125BAG1A connector manufactured by WIZnet, while RJ45 connector 260 may be implemented with a 2-406549-1 connector manufactured by TE Connectivity. In other embodiments, the same components may be used for both sides of the data diode 140.

In some embodiments, test sockets, such as test sockets 250A and 250B may be used for testing and debugging the hardware or firmware of the data diode 140. LEDs or other indicator devices may be included in the circuits of the data diode 140 to provide information for the operation or debugging of the device. In some embodiments, the data diode 140 may include a display screen or a connector for a display screen to provide operational information. Similarly, embodiments of the data diode 140 may include an input device or a connector for an input device to allow information to be input into the device, such as for configuration purposes.

Each of processing elements 215 and 220 may include memory and firmware loaded into the memory for the operation of the processing elements. The firmware comprises firmware to allow each of the processing elements 215 and 220 to act as a proxy for the source 110 or destination 120 and to manage the one-way communication between them even though either or both source and destination 110, 120 communicate with the data diode 140 using two-way communication protocols.

In various embodiments, the firmware loaded into memory on the processing elements 215 and 220 for converting two-way communication to one-way communication may be implemented on one or both processing elements 215 and 220. Embodiments may include firmware that detects the protocol used by source 110 or destination 120 and loads an appropriate conversion firmware module to convert the protocol used by source 110 or destination 120 into a one-way protocol for communicating between the processing elements 215, 220. Communication between the processing elements 215, 220 may be performed according to a standard one-way communication protocol or may be performed in some embodiments using a non-standard one-way protocol specifically designed for the data diode 140. For example, processing element 215 may detect a connection to source 110 that uses a TCP protocol and convert the TCP protocol into a UDP protocol for communicating with the processing element 220, which may then reconvert the UDP protocol into a TCP protocol for communicating with destination 120.

In one embodiment processing elements 215, 220 are preprogrammed with a plurality of protocol detection and conversion modules, allowing the data diode 140 to be placed into operation in a variety of environments without the need for pre-configuration. In some embodiments, because of the presence of a plurality of types of connectors on both the input and output sides of the data diode 140, the data diode 140 can be used with a connector to the source 110 of one type and a connector to the destination 120 of a different type. In some embodiments, control firmware may sequence between a predefined set of pre-loaded control protocols, such as BACnet, LonTalk, Modbus, DNP3, etc.) and determine what variables may be provided by the source 110, such as run time, system on/off status, temperature, fan speed, etc., and the processing element 215 or 220 may report those metrics across the optocoupler 205 at a predetermined interval or upon changes of the relevant metric. Similarly, in some embodiments, control firmware may sequence between a predefined set of pre-loaded control protocols for communicating with the destination. In some embodiments, one or more of processing elements 215 and 220 may encrypt the data received from the source 110 for delivery in encrypted form to destination 120, further enhancing the protection of the data from the source 110. Such encryption may be performed using any desired encryption technique, including symmetric and asymmetric encryption techniques.

In some embodiments, the source side processing element 215 or 220 may attempt to communicate using a preprogrammed sequence of queries until it has determined what protocols the source 110 uses and what variables the source 110 can report.

In addition to the data diode features described above, embodiments of the data diode 140 may include a network tap that allows the data diode 140 to monitor or intercept network traffic on a network link 180. Information about the data traversing network link 180 may then be transferred across the secure one-way communication link 170 to the destination 120. To avoid a risk that a malfunction of the data diode 140 might interfere with network traffic on the network link 180, the network tap feature is designed to revert to a straight passthrough should, for example, power to the data diode 140 be interrupted. The network tap features allow administrators to identify issues and analyze network anomalies with the data diode 140.

In some implementations, the data diode 140 may omit Ethernet connector 255 and Ethernet controller 245. In such an implementation, Ethernet communication through the data diode 140 would be through the network tap.

As illustrated in FIG. 2, two ports 202 and 204, typically configured as Rj45 connectors, provide the network tap, with the network link 180 connected to both ports 202 and 204. Data received on input port 202 is relayed by relay switch 206 to output port 204. The relay switch 206 is a double pole double throw signal relay switch, such as the G6K-2F-Y-TR DC3 low signal relay from Omron Electronics, which is connected in the ON position when the power is off. When the power to the data diode 140 is on, the relay switch 206 passes data received from port 202 to a network switch 212. The relay switch 206 is controlled by the CPU 215 so that the relay switch 206 is in the OFF state when power is on to the data diode 140. In the event of a power interruption, the relay switch 206 automatically switches to the ON position, allowing passing network data to the output port 204. This avoids interrupting traffic on the network link 180 should power be interrupted at the data diode 140.

Network switch 212 is preferably a 1000Base-T Ethernet switch, as defined by the IEEE 802.3ab standard, allowing the data diode 140 to monitor a network link 180 that is a Gigabit Ethernet network link capable of transmitting Ethernet frames at a rate of one gigabit per second. One example of such a switch is the KSZ9897 from Microchip Technology. However, implementations of the data diode 140 may be manufactured using either lower-speed or higher-speed switches as desired. In addition, implementations of the data diode 140 may be manufactured with network taps configured for non-Ethernet type network links if desired, substituting connectors and switches appropriate for the non-Ethernet type of network. Network switch 212 has at least three ports, allowing network switch 212 to duplicate or mirror port 202 onto port 204. Network switch 212 is controlled by CPU 215, which receives data via the network switch 212 from port 202. If CPU 215 detects an anomaly in the network traffic, CPU 215 may be programmed to cause an interruption of the data flow from port 202 to port 204 by controlling network switch 212 to stop mirroring the data flow to analog complementary metal-oxide-semiconductor (CMOS) switch 208.

Although illustrated using wired RJ45 connectors, the network tap capability is not limited to a wired network tap implementation. For example, WI-FI® implementations may use wireless network elements for a wireless network tap. (WI-FI is a registered trademark of the Wi-Fi Alliance.) In another example, cellular implementations may use wireless antennae and appropriate cellular components for providing a data diode that listens to 5G or other cellular communications. These are illustrative and by way of example only. One of skill in the art will recognize data diodes 140 may be implemented with a plurality of types of listening capabilities, such as a combination of wired and wireless and combinations of different network protocol capabilities.

When power is on for the data diode 140, data received via port 202 is switched by the network switch 212 to CPU 215 and to an analog CMOS switch 208, which then passes the received data out on port 204. Under normal circumstances, network traffic flows unimpeded and unchanged from port 202 through the data diode 140 as if the data diode 140 was not present and tapping the network link 180. In one embodiment, the analog CMOS switch is an 8-channel single pole single throw (SPST) switch connected to the ON position when power is supplied to the data diode 140. Thus, when power is supplied to the data diode 140, data flows from input port 202 to the relay switch 206, then to the network switch 212, and back to analog CMOS switch 208 for transmittal via port 204. When power is off to the data diode 140, the analog CMOS switch 208 switches to a high impedance state, and network data stops being transmitted through the analog CMOS switch 208 to port 204, disconnecting the network switch 212 from port 204. In that state, data flows from the relay switch 206 to the output port 204. Any desired analog CMOS switch 208 may be used, such as the MAX395 8-channel analog switch from Maxim Integrated. In addition, although described herein as an analog CMOS switch, other SPST switch technology can be used.

Although some embodiments may be implemented with a single circuit board 200 as illustrated in FIG. 2, embodiments may be implemented with two separate circuit boards that are connected by the optocoupler 205. The specific connectors and supporting interface circuits illustrated in FIG. 2 are illustrative and by way of example only, and other connectors and supporting interface circuits may be used. In some embodiments, some of the components illustrated as separate components in FIG. 2 may be combined into one or more integrated components and in some embodiments components illustrated in FIG. 2 may be split into multiple components that together perform the desired function. The arrangement of components on the circuit board 200 of FIG. 2 is illustrative and by way of example only, and other arrangements can be used as desired. For example, in the illustrated embodiment of FIG. 2, the connectors 235, 240, 255, 260, 295, and 290 are on various edges of the circuit board 200, but in some embodiments, all of the connectors may be disposed on a single edge of the circuit board 200.

The circuit board 200 and the components disposed thereon are typically housed in a protective housing (not shown in the figures), which may be of any desired shape and configuration. For example, the data diode 140 may be housed in a 1 U form factor case for mounting in a standard rack. In some embodiments, a transparent window may allow viewing LEDs or other indicators disposed on the circuit board 200 to indicate the state of the data diode 140. Some embodiments may provide a housing (not shown in the figures) that employs tamper-resistant techniques to prevent or detect tampering with the data diode 140. In some embodiments, a plurality of data diodes 140 may be housed in a common housing to act as channels for separate communication paths, where a plurality of links are desired between a single source 110 and a single destination 120, a single source 110 and a plurality of destinations 120, a plurality of sources 110 and a single destination 120, or a plurality of sources 110 and a plurality of destinations 120.

Although preferably preconfigured to be plugged in and automatically activated, some embodiments may allow configuration of the data diode 140 at the installation site or elsewhere prior to operation. In some embodiments, the data diode 140 is not configurable on-site. In some embodiments, any type of wired or wireless connection technique may be used to connect the data diode 140 to another device, such as a mobile device with an appropriate app, for in-field setup or management of the data diode 140 and for collecting information from the data diode 140 regarding its operation. A geolocation module (not shown in FIG. 2) may be incorporated in some embodiments to allow the data diode 140 to report its location as geolocation coordinates based on geolocation data from a global satellite-based navigation system or other geolocation data providers.

Although described above in terms of wired interfaces to the data diode 140, wireless interfaces may be implemented. For example, outbound connectivity may be provided by an outbound communication interface that comprises a cellular modem and an antenna for communicating with a cellular network, such as is described in U.S. Pat. No. 10,474,613, entitled “ONE-WAY DATA TRANSFER DEVICE WITH ONBOARD SYSTEM DETECTION,” which is incorporated herein in its entirety for all purposes.

Other types of wireless communication components may be deployed in various embodiments allowing for non-cellular wireless communication with either or both the inbound and outbound side of the data diode 140, in addition to or instead of cellular or wired connectivity. For example, wireless components can be deployed for WI-FI®, Bluetooth®, LORA®, satellite, ZIGBEE®, and ZWAVE communications, and any other desired type of wireless communications. (WI-FI is a registered trademark of WiFi Alliance; Bluetooth is a registered trademark of Bluetooth SIG, Inc.; LORA is a registered trademark of Semtech Corporation; ZIGBEE is a registered trademark of ZigBee Alliance; Z-WAVE is a registered trademark of Silicon Laboratories, Inc.) Any combination of any of the wired or wireless (including cellular) communication techniques may be provided on either the inbound or outbound side of the data diode 140.

In some embodiments, the data diode 140 may be configured with reporting firmware to allow a cloud-based data collection, display, and analytics platform to collect usage data from the data diode 140 and allow a user to create custom alerts, detect tampering with the data diode 140, and receive recommended actions drawn from predictive analytics.

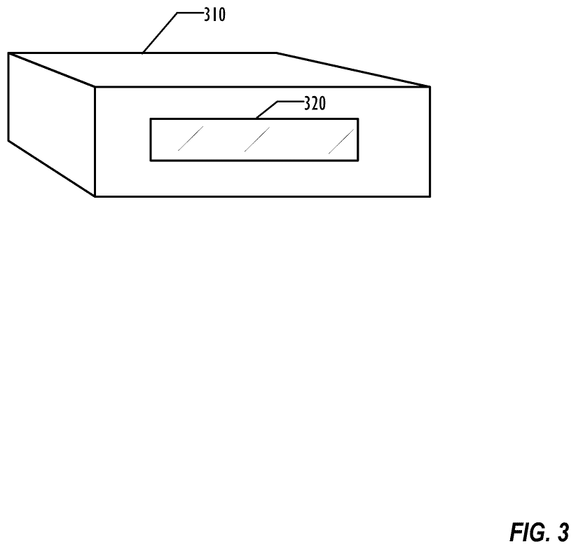

The circuit board 200 and the components disposed thereon are typically housed in a protective housing 310 as illustrated in FIG. 3, which may be of any desired shape and configuration. For example, the data diode 140 may be housed in a 1 U form factor case for mounting in a standard rack. In some embodiments, a transparent window 320 may allow viewing LEDs or other indicators disposed on the circuit board 200 to indicate the state of the data diode 140. Some embodiments may provide a housing 310 that employs tamper-resistant techniques to prevent or detect tampering with the data diode 140. In some embodiments, a plurality of data diodes 140 may be housed in a common housing 310 to act as channels for separate communication paths, where a plurality of links are desired between a single source 110 and a single destination 120, a single source 110 and a plurality of destinations 120, a plurality of sources 110 and a single destination 120, or a plurality of sources 110 and a plurality of destinations 120.

In some embodiments, the data diode 140 may be implemented with a secure reverse channel, such as is described in U.S. Pat. No. 11,153,345, “One-Way Transfer Device with Secure Reverse Channel,” which is incorporated herein by reference in its entirety for all purposes. In such an implementation, commands received via the secure reverse channel by the CPU 215 may be used to control the operation of the network switch 212, the relay switch 206, and the analog CMOS switch 208. For example, if an anomaly is detected in the network traffic monitored by the data diode 140, a command may be sent via the secure reverse channel to interrupt the network connection between port 202 and port 204. In addition or alternately, commands received via the secure reverse channel may be used to cause the CPU 215 to inject data into the network traffic monitored by the data diode 140 or to transmit information or commands to the source 110 as a way of responding to the detected anomaly.

In embodiments where the data diode 140 is implemented without a secure reverse channel, the CPU 215 may be pre-programmed to take predetermined actions upon detecting corresponding conditions, such as the detection of a network anomaly. As with the secure reverse channel implementation, those predetermined actions may include interruption of the network data flow, injecting data into the network data flow, or transmitting information or commands to the source 110.

Thus, for example, the data diode 140 may be switched between passive listening and active network participation. In implementations where the data diode 140 does not include a secure reverse channel, the CPU 215 may be programmed to switch between passive listening and active network participation based on one or more of analysis of the network traffic, time and date schedules, or any other trigger that may be programmed into the CPU 215. In implementations where the data diode 140 includes a secure reverse channel, the CPU 215 may also be programmed to switch between passive listening and active network participation based on commands received via the secure reverse channel. Thus, for example, the CPU 220 may be programmed to examine data received from the CPU 215 and make decisions about commands to send related to passive listening or active participation via the secure reverse channel, receive instructions from destination 120 for sending to the CPU 215, etc. Examples of active participation may include actively polling MODBUS® registers or establishing a connection with an FTP client. (MODBUS is a registered trademark of Schneider Electric USA, Inc.) One of skill in the art will recognize that other types of active participation may be performed by the CPU 215.

While certain example embodiments have been described in detail and shown in the accompanying drawings, it is to be understood that such embodiments are merely illustrative of and not devised without departing from the basic scope thereof, which is determined by the claims that follow.

We claim:

1. A data diode, comprising:
a first network interface circuitry, comprising:
a first processing element;
a first network connector, coupled to the first processing element; and
a second network interface circuitry, comprising:
a second processing element; and
a second network connector, coupled to the second processing element;
a one-way data bridge coupled between the first processing element and the second processing element that allows data flow from the first processing element to the second processing element and physically prohibits data flow from the second processing element to the first processing element; and
a network tap, comprising:
a first network port;
a second network port; and
a network switch, configured to mirror network traffic received from the first network port to both the first processing element and the second network port.

2. The data diode of claim 1, wherein the network tap further comprises:
a relay switch, connected between the first network port and the network switch, configured to pass network traffic from the first network port to the second network port upon a power loss by the data diode.

3. The data diode of claim 2, wherein the network tap further comprises:
an analog switch, connected to the network switch and the second network port, configured to disconnect the second network port from the network switch upon the power loss by the data diode.

4. The data diode of claim 3, wherein the analog switch is further connected to the relay switch.

5. The data diode of claim 1, wherein the first processing element is programmed to:
detect an anomaly in the network traffic; and
control the network switch to stop mirroring data flow toward the second network port.

6. The data diode of claim 1, wherein the first processing element is programmed to monitor the network traffic and send information about the network traffic to the second processing element via the one-way data bridge.

7. A network tap, comprising:
a one-way data bridge having a first end and a second end that allows data flow from the first end to the second end and physically prohibits data flow from the second end to the first end;
a first network port;
a second network port; and
a network switch, configured to mirror network traffic received from the first network port to both the second network port and the first end of the one-way data bridge.

8. The network tap of claim 7, wherein the first end of the one-way data bridge comprises a first processing element.

9. The network tap of claim 8, wherein the first processing element is programmed to:
detect an anomaly in the network traffic; and
control the network switch to stop mirroring the network traffic toward the second network port responsive to detecting the anomaly.

10. The network tap of claim 8, further comprising a first network connector, coupled to the first processing element.

11. The network tap of claim 7, wherein the second end of the one-way data bridge comprises a second processing element.

12. The network tap of claim 11, further comprising a second network connector, coupled to the second processing element.

13. The network tap of claim 7, further comprising a relay switch, connected between the first network port and the network switch, configured to pass network traffic from the first network port to the second network port upon a power loss by the network tap.

14. The network tap of claim 7, further comprising an analog switch, connected to the network switch and the second network port, configured to disconnect the second network port from the network switch upon a power loss by the network tap.

15. The network tap of claim 7, wherein the one-way data bridge comprises a photocoupler.

16. A method of tapping a network, comprising:
receiving network traffic by a first network port;
sending the network traffic from the first network port to a network switch;
mirroring the network traffic by the network switch to both a first processing element of a data diode and a second network port; and
sending the network traffic or information about the network traffic from the first processing element of the data diode to a second processing element of the data diode via a one-way data bridge that physically prohibits data flow from the second processing element to the first processing element.

17. The method of claim 16, further comprising:
disconnecting the network switch from the second network port upon power loss.

18. The method of claim 17, wherein disconnecting the network switch from the second network port upon power loss comprises:
switching an analog switch from a first state to a second state upon loss of power;
sending the network traffic from the network switch through the analog switch to the second network port in the first state; and
disconnecting the network switch from the second network port in the second state.

19. The method of claim 16, wherein sending the network traffic from the first network port to the network switch comprises:
sending the network traffic from the first network port to a relay switch coupled to both the network switch and the second network port;
sending the network traffic from the relay switch to the network switch while power is on to the relay switch; and
sending the network traffic from the relay switch to the second network port upon loss of power by the relay switch.

20. The method of claim 16, further comprising:
detecting by the first processing element an anomaly in the network traffic received from the network switch; and
interrupting data flow from the first network port to the second network port responsive to detecting the anomaly.
